(19) United States
(12) Patent Application Publication
(10) Pub. No.: US 2026/0126821 A1
(43) Pub. Date: May 7, 2026

(54) SYSTEM FOR MONITORING AND CONTROLLING PIPE TEMPERATURE

(71) Applicants: Daryl B. Alexander, East Lansing, MI (US); Randolph Louis Abidin, Vienna, VA (US)

(72) Inventors: Daryl B. Alexander, East Lansing, MI (US); Randolph Louis Abidin, Vienna, VA (US)

(21) Appl. No.: 19/407,692

(22) Filed: Dec. 3, 2025

Related U.S. Application Data
(60) Provisional application No. 63/716,604, filed on Nov. 5, 2024.

(51) Int. Cl. G05D 23/19; E03B 7/12

(52) U.S. Cl. CPC G05D 23/1917; E03B 7/12

(57) ABSTRACT

A system for monitoring and controlling pipe temperature to prevent freezing comprises a heating apparatus, at least one processor, and a memory storing executable instructions. The processor receives temperature readings from a sensor coupled to the pipe and determines the pipe's state based on these readings. The system automatically controls the heating apparatus based on the determined state, including detecting rapid temperature drops by calculating temperature change rates over time. A mobile computing device communicatively couples to the processor, enabling remote monitoring and manual override capabilities. The system continuously monitors pipe temperature, activating heat tape when temperatures fall below thresholds or when rapid temperature drops are detected, and deactivating when safe temperatures return. This automated protection system addresses the critical need for real-time pipe monitoring in vulnerable housing structures, preventing costly freeze damage without requiring extensive modifications to existing plumbing infrastructure.

### CROSS-REFERENCE TO RELATED APPLICATIONS

This application claims benefit to Provisional Application No. 63/716,604, filed Nov. 5, 2024, the contents of which are herein incorporated by reference.

### BACKGROUND OF THE INVENTION

### Field of Endeavor

The present invention relates to pipe monitoring systems, and more particularly, to a system for monitoring and controlling the temperature of a pipe to prevent catastrophic failure thereof.

### Background of Related Art

Piping structures commonly used in residential homes, especially those with cold crawl spaces, and particularly prevalent in mobile homes, manufactured homes, and modular homes, are highly susceptible to freezing. Such freezing events frequently lead to pipes bursting, resulting in significant water damage to the property and incurring substantial repair expenses for homeowners.

A critical deficiency in existing solutions is the lack of direct control and real-time monitoring of heat tape systems and the overall piping infrastructure within these vulnerable housing structures. Manual systems require users to physically turn heat tapes on and off, which can be inefficient and susceptible to human error, particularly during unexpected temperature drops or when homeowners are absent. Furthermore, many conventional pipe protection methods require extensive and costly modifications to a home's existing electrical and water piping systems. These modifications often involve the installation of complex components such as pressure sensors, bypass valves, and secondary drainage systems, typically requiring the expertise and expense of professional plumbers.

The financial burden imposed by frozen and burst pipes is considerable. According to 2023 State Farm claims data 1, the company processed more than 17,200 claims directly related to frozen pipes, resulting in payouts exceeding $432.5 million, with the average claim amounting to over $23,500. States most affected by these claims in 2023 included Texas ($64 million), New York ($17 million), Illinois ($10.8 million), Michigan ($7.2 million), Colorado ($6.5 million), Washington ($6.4 million), Minnesota ($6.3 million), Pennsylvania ($5.7 million), Alaska ($4.3 million), and Connecticut ($3.8 million).

As can be seen, there is a need for a system for monitoring and controlling the temperature status of a pipe to prevent catastrophic failure.

### SUMMARY OF THE INVENTION

Embodiments of the present invention include a system and method for monitoring and controlling a temperature of a pipe. The system includes a plurality of components, such as, a heating apparatus, at least one sensor, at least one processor, and a memory storing instructions that when executed by the processing cause the processor to perform a method. The method of the present invention receives temperature readings of the pipe from the sensor and calculates a first temperature condition using the temperature reading. The first temperature condition is compared to a rapid temperature drop threshold, and in response the first temperature condition being above a threshold the heating apparatus is activated. In response to the first temperature condition being below the threshold, the temperature reading is compared to a second threshold. In response to the temperature reading being at or below the second threshold the heating apparatus is activated. Finally, in response to the temperature reading being above the second threshold the heating apparatus is deactivated.

### BRIEF DESCRIPTION OF THE DRAWINGS

FIG. 1 is a schematic diagram of a system for monitoring and controlling pipe temperature, according to aspects of the present invention;

FIG. 2 is a flow diagram of a method of configuring a system for monitoring and controlling pipe temperature, according to aspects of the present invention;

FIG. 3 is a flow diagram of an overall method of monitoring and controlling pipe temperature, according to aspects of the present invention;

FIG. 4 is a sub-flow diagram of a method controlling pipe temperature and rapid temperature drop detection, according to aspects of the present invention;

FIG. 5 is a sub-flow diagram of a method for activating and deactivating temperature control systems, according to aspects of the present invention;

FIG. 6 is a sub-flow diagram of a method for activating and deactivating temperature control systems, according to aspects of the present invention; and

FIG. 7 is a flow diagram of a method of delivering key indicators, according to aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As stated above, plumbing systems are susceptible to damage from freezing temperatures, and are not easily monitored due to their placement in building structures. Repair and remediation of damage to plumbing systems is both time-consuming and expensive to repair and remediate.

Broadly, an embodiment of the present invention provides a system for monitoring and controlling the temperature of a pipe. The system of the present invention includes a first computing device, a second computing device, a temperature sensor, and a heating apparatus. The first computing device is coupled to the temperature sensor, and the heating apparatus and includes instructions to receive a temperature reading from the temperature sensor, and control the heating apparatus in response to the temperature reading. The second computing device is communicative coupled to the first computing device and includes instructions for monitoring temperatures received by the first computing device, and/or instructions to control the heating apparatus.

Broadly, embodiments of the present invention include computer-implemented methods for performing functions associated with the system of the present invention.

Broadly, an embodiment of the present invention provides a method for setting up the system of the present invention. The method begins on startup of the first computing device and determines if one or more components of the system are set-up, or exist, and either sets up the missing components, or activates the system as ready for use.

Broadly, an embodiment of the present invention provides a method for monitoring and controlling the temperature of a pipe. The method receives temperature reading(s) from one or more sensors. In response to receiving the temperature reading(s) a determination is made if a first temperature condition exists. In response to the first temperature condition existing a heating apparatus is activated, and statuses associated with the heating apparatus and the first temperature condition are updated. In response to the first temperature condition not existing the status of the first temperature condition is updated, and a determination is made if a second temperature condition exists.

In response to the second temperature condition existing the heating apparatus is activated and statuses associated with the heating apparatus and the second temperature condition are updated. In response to the second temperature condition not existing the heating apparatus is de-activated and statuses associated with the heating apparatus and the second temperature condition are updated, and control returns to receiving temperature readings from the one or more sensors. The method for monitoring and controlling the temperature of a pipe runs continuously on the system of the present invention, polling the temperature from the one or more sensors and controlling the heating apparatus in response to the methodological logic.

Broadly, an embodiment of the present invention provides a method of determining the first temperature condition and controlling the heating apparatus according to the first temperature condition. The method receives a plurality of temperature readings. After receiving the plurality of temperature readings, a determination is made as to whether to turn the heating apparatus on, or off. The determination utilizes the existence of the first temperature condition and one or more of the plurality of temperature readings. In response to the first temperature condition existing and the one or more of the plurality temperature readings being below a threshold, the heating apparatus is turned on and statuses associated with the heating apparatus and the first temperature condition are updated. In response to either of the above conditions not being met, the heating apparatus is turned off and statuses associated with the heating apparatus and the first temperature condition are updated.

Broadly, an embodiment of the present invention provides a method of controlling the heating apparatus for a fixed temperature threshold. The method receives a temperature reading(s) from one or more sensors. In response to receiving the temperature readings a determination is made as to whether the temperature is below a threshold, and if so the heating apparatus is activated, a status of the heating apparatus is updated, and control returns to receiving the temperature readings from the one or more sensors. If the temperature is not below a threshold a determination is made as to whether the temperature plus a hysteresis amount are above a threshold, and if so the heating apparatus is deactivated, a status of the heating apparatus is updated, and control returns to receiving the temperature readings from the one or more sensors. If the temperature plus the hysteresis is not above a threshold control returns to receiving the temperature readings from the one or more sensors.

Broadly, an embodiment of the present invention provides a method of monitoring and controlling the heating apparatus. The method receives a temperature reading(s) from one or more sensors and receives a manual status of the heating apparatus. In response to receiving the temperature readings a determination is made as to whether the temperature is below a threshold, and if not the heating apparatus is de-activated, the manual status of the heating apparatus is updated, the status of the heating apparatus is updated, and control returns to receiving the temperature readings from the one or more sensors. If the temperature is below the threshold, a determination is made as to whether the manual status of the heating apparatus is active, and if so the heating apparatus is activated, the manual status of the heating apparatus is updated, the status of the heating apparatus is updated, and control returns to receiving the temperature readings from the one or more sensors. If the manual status of the heating apparatus is not active control returns to receiving the temperature readings from the one or more sensors.

Broadly, an embodiment of the present invention provides a method of delivering key performance indicators (KPI) of one or more sensor(s). The method receives a request, from a computing device, for key performance indicators, and/or settings for the one or more sensor(s). In response to the request, a determination is made if a service associated with the one or more sensor(s) is running, and if not, an error message related thereto is added to a KPI list and control continues. If the service is running, the KPI list and/or one or more settings are returned to the computing device which displays and/or stores the KPI list and/or the one or more settings thereon.

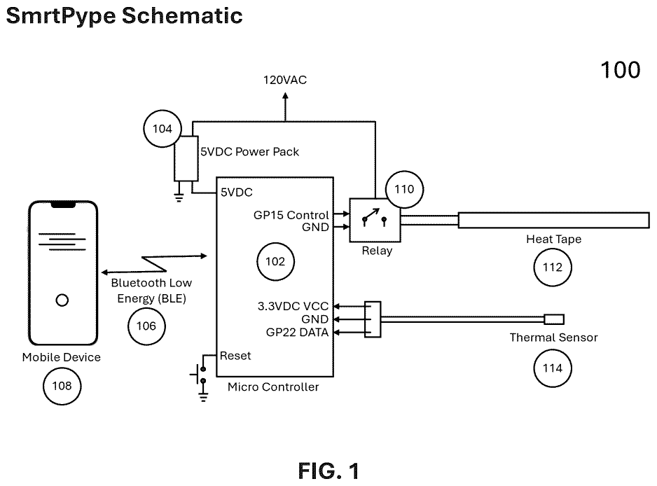

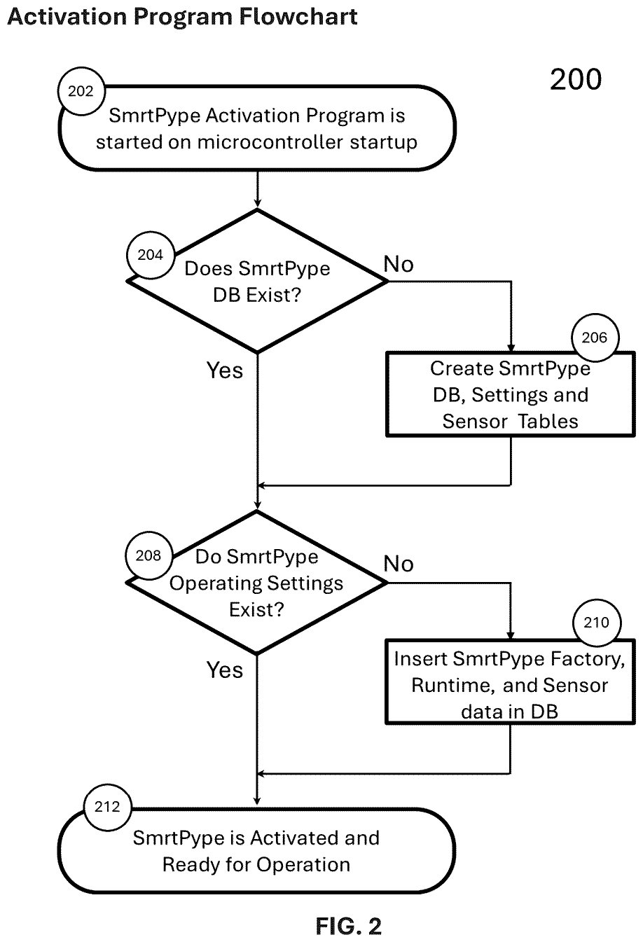

Referring now to the Figures, FIGS. 1-7 illustrate aspects of a system for monitoring and controlling pipe temperature, according to aspects of the present invention. Briefly, FIG. 1 illustrates a schematic diagram of a system for monitoring and controlling pipe temperature, while FIGS. 2-7 illustrate flow diagrams of methods utilized in the system.

FIG. 1 illustrates a schematic diagram of a system 100 for monitoring and controlling pipe temperature. System 100 includes a plurality of components, such as, a computing device 102, a power pack 104, a mobile computing device 108, a relay 110, a heating apparatus 112, and a temperature sensor 114.

Computing device 102 controls system 100 by receiving data, outputting, and/or processing data associated with components of system 100. In embodiments, computing device 102 is a microcontroller, but is not so limited. Additionally, computing device 102 includes one or more programs, modules, etc., configured for monitoring and controlling pipe temperature.

Power pack 104 provides power to computing device 102. In embodiments, power pack 104 is a 5-volt Direct Current (DC) power supply but is not so limited. Power pack 104 can be a rechargeable power supply and can receive power from an additional power source, such as a 110-volt Alternative Current (AC) power source.

Relay 110 operates as a switch to conditionally provide power to heating apparatus 112. Relay 110 is coupled to a power source, such as a 110-volt AC power source, and to computing device 102. In response to a command from computing device 102 relay 110 operates to connect/disconnect the power source from heating apparatus 112, thereby turning heating apparatus 112 on/off.

Temperature sensor 114 is coupled to computing device 102 and provides temperature readings thereto for use in controlling heating apparatus 112. Temperature sensor 114 can provide temperature readings to computing device 102 periodically, such as every 5-10 seconds.

Computing device 102 is communicatively coupled to mobile computing device 108 through a communications protocol, such as Bluetooth Low Energy, Wi-Fi, Cellular, 5G, 6G, etc., which allows computing device 102 to send/receive data to/from mobile computing device 108, and vice versa.

FIG. 2 illustrates a method 200 of configuring system 100 for monitoring and controlling pipe temperature, according to aspects of the present invention.

Method 200 begins at step 202 with an activation module, or program, starting on computing device 102. In response to the activation module starting, a determination is made at 204, if a system database exists, and if not the system database, including one or more settings and/or sensor tables are created at 206. If the system database does exist, control passes, and a determination is made if one or more operating settings exist at 208, and if not the one or more operational settings are created at step 210. In embodiments, the one or more operational settings include a system factory settings, runtime settings, and/or sensor data settings for the system database. If the one or more operational settings do exist, the system is activated and ready for operation.

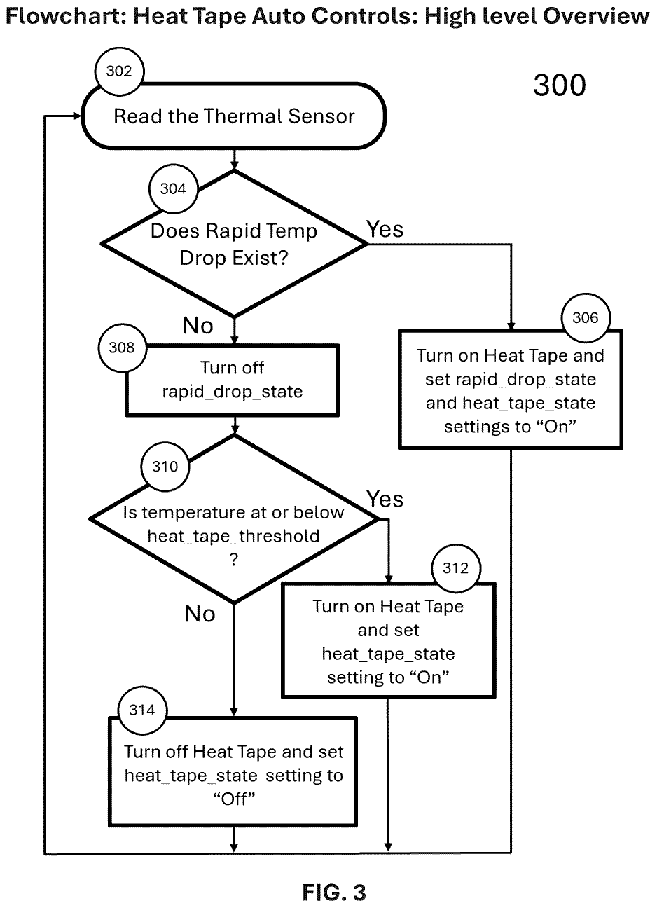

FIG. 3 illustrates a method 300 of automatically monitoring and controlling pipe temperature, according to aspects of the present invention.

Method 300 begins, at 302, by receiving at least one temperature from a temperature sensor coupled to a pipe. In response to receiving the at least one temperature one or more conditions and/or settings are determined.

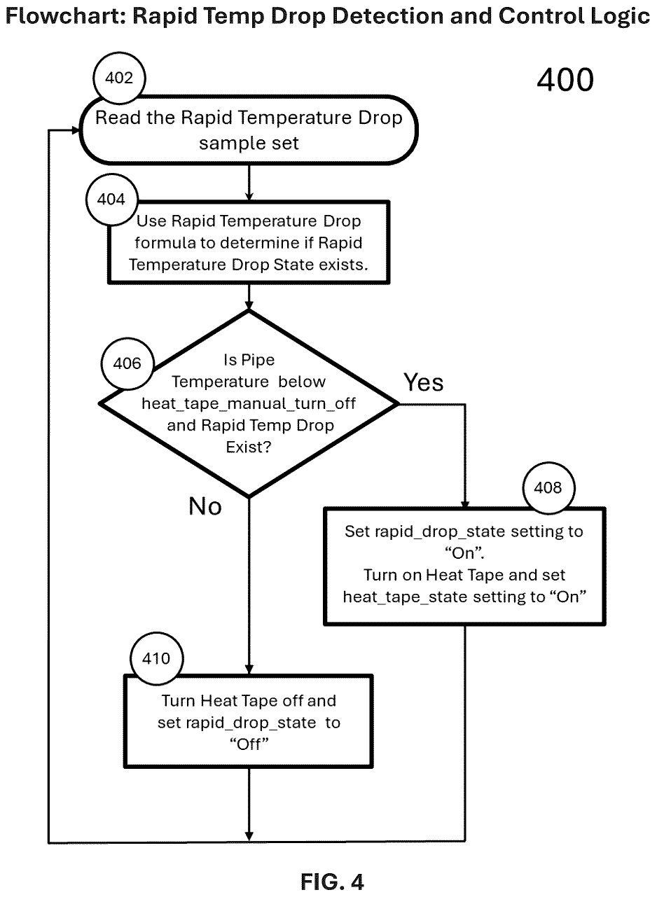

At 304, a determination utilizes the at least one temperature to determine if a rapid temperature drop condition exists, described further with respect to FIG. 4.

At 306, in response to the rapid temperature drop condition existing, a heating apparatus is activated, and one or more settings are set. In embodiments, the one or more settings include a rapid drop status, and/or a heat tape setting. In embodiments, in response to the rapid drop condition existing, the rapid drop status and the heat tape setting are both set to an ‘ON’ condition. Once the heating apparatus is activated, and the one or more settings are set, control then returns to 302.

At 308, in response to the rapid temperature drop condition not existing, the heating apparatus is deactivated, and the one or more settings are set. In embodiments, in response to the rapid drop condition existing, the rapid drop status and the heat tape setting are both set to an ‘OFF’ condition. Once the heating apparatus is deactivated, and the one or more settings are set, control proceeds to 310.

At 310, a determination is made as to whether the at least one temperature is at, or below a heating threshold. In embodiments, the heating threshold factory setting is 35 F.

At 312, in response to the at least one temperature being at or below the heating threshold, the heating apparatus is activated, and one or more settings are set. In embodiments, the one or more settings include the heat tape setting. In embodiments, in response to the at least one temperature being at or below the heating threshold, the heat tape setting is set to an ‘ON’ condition. Once the heating apparatus is activated, and the one or more settings are set, control then returns to 302.

At 314, in response to the at least one temperature not being at or below the heating threshold, the heating apparatus is deactivated, and one or more settings are set. In embodiments, in response to the at least one temperature not being at or below the heating threshold, the heat tape setting is set to an ‘OFF’ condition. Once the heating apparatus is deactivated, and the one or more settings are set, control then returns to 302.

FIG. 4 illustrates a method 400 of controlling pipe temperature and rapid temperature drop detection, according to aspects of the present invention.

Method 400 begins, at 402, by receiving at least one temperature from a temperature sensor coupled to a pipe. More specifically, a plurality of temperatures are received over a period of time, at 402. In embodiments, each time the at least one temperature is received by system 100 it is stored in the system database. At 402, the at least one temperature received is a sample of the temperatures from a current temperature to each preceding temperature over the period of time. For example, the sample can be all temperatures received in the immediately preceding seconds, minutes, etc.

At 404, the at least one temperature, or sample, is utilized in a calculation to determine the rapid temperature condition. In embodiments, the status is ‘ON’ if the at least one temperature, or sample, indicates that the temperature has dropped a threshold number of degrees over a set time period, and the status is ‘OFF’ otherwise.

At 406, the rapid drop condition and one of the at least one temperature are utilized to determine an activation condition of the heating apparatus. Specifically, the most current temperature of the at least one temperature is compared to a threshold to determine if it is below a manual shutoff for the heating apparatus, and the rapid drop condition status is polled.

At step 408, in response to the most current temperature being below the threshold, and the rapid drop condition being set to ‘ON’, the heating apparatus is activated, and the heat tape setting is set to ‘ON’. Once the heating apparatus is activated, and heat tape setting is set to ‘ON’, control is returned to 402.

At step 410, in response to either of the most current temperature being above the threshold, or the rapid drop condition being set to ‘OFF’, the heating apparatus is deactivated, and the heat tape setting is set to ‘OFF’. Once the heating apparatus is deactivated, and heat tape setting is set to ‘OFF’, control is returned to 402.

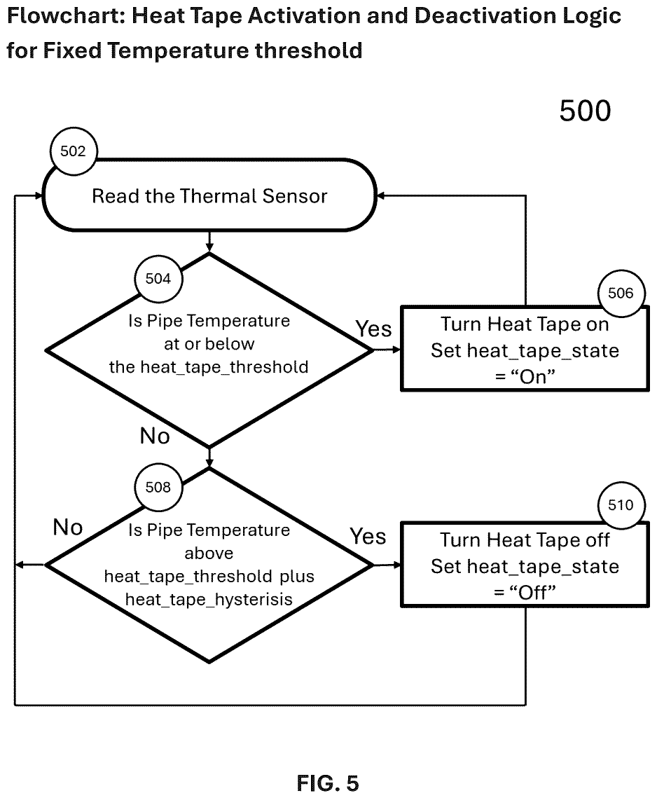

FIG. 5 illustrates a method 500 for activating and deactivating temperature control systems, according to aspects of the present invention.

Method 500 beings, at 502, by receiving at least one temperature from a temperature sensor coupled to a pipe. In response to receiving the at least one temperature one or more conditions and/or settings are determined.

At 504, the at least one temperature is compared to a heating threshold to determine if the at least one temperature is at or below the heating threshold.

At 506, in response to the at least one temperature being at or below the heating threshold, the heating apparatus is activated, and one or more settings are set. In embodiments, the one or more settings include the heat tape setting. In embodiments, in response to the at least one temperature being at or below the heating threshold, the heat tape setting is set to an ‘ON’ condition. Once the heating apparatus is activated, and the one or more settings are set, control then returns to 502.

At 508, in response to the at least one temperature not being at or below the heating threshold, a second determination is made. Specifically, the at least one temperature is compared to the heating threshold plus a heating hysteresis amount. In response to the at least one temperature not being above the heating threshold plus hysteresis, control returns to 502.

At 510, in response to the at least one temperature being at or the heating threshold plus hysteresis, the heating apparatus is deactivated, and one or more settings are set. In embodiments, in response to the at least one temperature not being at or below the heating threshold plus hysteresis, the heat tape setting is set to an ‘OFF’ condition. Once the heating apparatus is deactivated, and the one or more settings are set, control then returns to 502.

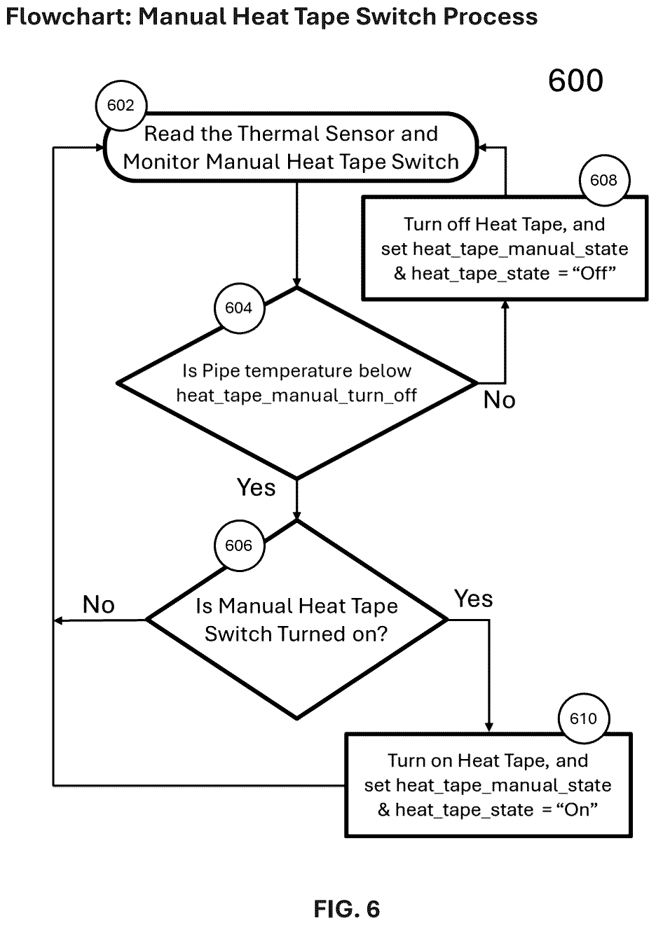

FIG. 6 illustrates a method 600 for activating and deactivating temperature control systems, according to aspects of the present invention.

Method 600 begins, at 602, by receiving at least one temperature from a temperature sensor coupled to a pipe and one or more settings. In response to receiving the at least one temperature and the one or more settings, one or more conditions and/or settings are determined.

At 604, the at least one temperature is compared to a threshold, to determine if the at least one temperature is below the threshold. In embodiments, the threshold is indicative of a maximum temperature for the pipe. In response to the at least one temperature not being below the threshold, the heating apparatus is deactivated, and one or more settings are set, at 608. In embodiments, the one or more settings are the heat tape state, and/or a heat tape manual state. In embodiments, the heat tape manual state is an indicator that the heating apparatus is in a manual state. In embodiments, the heat tape state is set to ‘OFF’ and the heat tape manual state is set to ‘OFF’, at 608.

At 606, in response to the at least one temperature being below the threshold, a secondary determination is made. Specifically, a state of the switch of the heating apparatus is checked to determine if the heating apparatus switch is in a manual position. In response to the switch not being in a manual position, control is returned to step 602.

At step 610, in response to the switch being in a manual position, the heating apparatus is activated, and one or more settings are set. In embodiments, the one or more settings are the heat tape state, and/or the heat tape manual state. Specifically, the heat tape state and/or the heat tape manual state are set to ‘ON’ in response to the switch being in a manual position at 610. Once set, control returns to step 602.

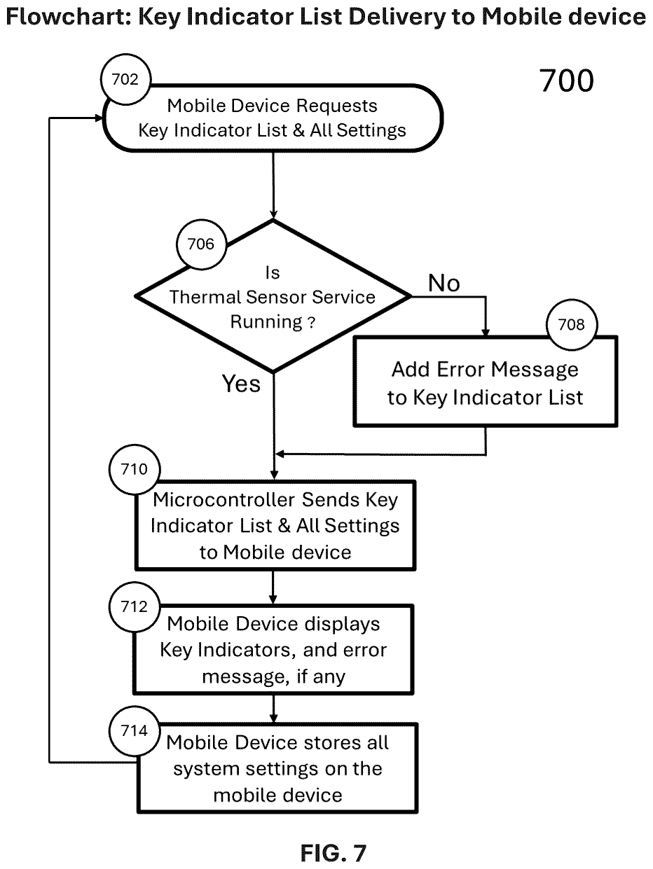

FIG. 7 illustrates a method 700 of delivering key indicators, according to aspects of the present invention.

Method 700 begins, at 702, when a first computing device, such as mobile computing device 108, requests data from a second computing device, such as computing device 102. In embodiments, requested data includes, but is not limited to, one or more indicators, statuses, states, and/or settings, related to, or associated with a heating apparatus, or a system for controlling the heating apparatus.

At 706, the second computing device determines if a specified service is available and running thereon. Specifically, the specified service is a service configured to monitor the temperature sensor coupled to the second computing device. In response to the specified service not running on the second computing device an error message is added to a list, at step 708, and control is passed to 710.

At 710, in response to the specified service being available and running, the second computing device sends the list to the first computing device. In embodiments, the list includes data related to, or associated with, the heating apparatus, or the system for controlling the heating apparatus. More specifically, the data includes key performance indicators of the heating apparatus/system, settings of the heating apparatus/system, and one or more error messages of the heating apparatus/system.

At 712, the first computing device displays the list, or a subset thereof, to a user.

At 714, the first computing device stores the list, or a subset thereof, thereon.

Referring now to exemplary scenarios, use-cases, and/or embodiments, computing device 102 serves as the central intelligent unit for System 100, as an Internet of Things (IoT) device. Computing device 102 is powered by the 5 VDC power supply 104, and reads sensor data directly from the Temperature Sensor 114. The sensor data, including temperature readings, is displayed to the user via an application running on mobile computing device 108. Computing device 102 is connected to the relay 110 and switches the relay on and off based on the received sensor data, and/or one or more settings. The heating apparatus 112, as heat tape, is turned on and off by relay 110. The mobile application of mobile computing device 108 also allows the user to monitor the heat tape's on/off status, which is controlled by computing device 102, and provides the capability for the user to manually override and control the heat tape's on/off state as needed.

In a specific operational embodiment, microcontroller 102 reads the thermal sensor 114 periodically, typically every 5-10 seconds. A program running on microcontroller 102 has three major control components that monitor the pipe temperature and variations in the temperature to automatically protect heat tape 112 and keep the pipe from freezing. Mobile device 108 includes a manual heat tape on/off switch that the user can manually activate if they feel freezing weather is imminent (there is a weather site API installed in a separate screen on the mobile device to access the local forecast). Lastly, there is a heat tape high temperature limit the program uses to automatically turn off the heat tape for safety reasons.

In use, System 100 is designed for intuitive and straightforward use by the average consumer, requiring no specialized technical expertise beyond the ability to interact with a mobile application. Usage of System 100 is divided into three primary phases: initial setup, daily monitoring, and manual intervention.

Initial Setup: A user begins by physically installing System 100, by securely attaching the heat tape 112 in FIG. 1, along the length of a water pipe to be protected. The microcontroller 102 with its integrated temperature humidity sensor 114 is placed in a location where it can accurately measure the pipe temperature. Microcontroller 102 is powered by connecting it to a standard 120 VAC power source via the 5 VDC power pack 104. The microcontroller 102 is now ready to pair.

The user then opens a mobile application running on mobile computing device 108 follows the on-screen prompts to establish a Bluetooth Low Energy (BLE) connection 106 with Microcontroller 102. Microcontroller 102 comes pre-configured with one or more settings in a default configuration, such as temperature thresholds and operational parameters, which are immediately active when powered on.

Daily Monitoring: Once the setup is complete, System 100 operates autonomously. The microcontroller 102 continuously monitors the temperature around the pipe via the sensor 114. The mobile application provides a real-time display of several system states, including the apparatus health, current temperature, the status of the heat tape (on/off) and the existence of a rapid temperature drop state. When the temperature drops below the pre-set freezing threshold or a rapid temperature drop state is detected, the microcontroller 102 automatically activates relay 110, which in turn switches on the heat tape 112. Heat tape 112 remains active until the temperature rises back to an acceptable level and no rapid temperature drop state exists. The mobile application notifies the user when the heat tape is activated and deactivated, providing proactive peace of mind without requiring constant user attention.

Manual Intervention: The Mobile application provides the user with the ability to manually override the automatic controls. In situations where the user anticipates freezing conditions (e.g., an imminent severe weather forecast), the user can manually activate the heat tape 112 directly from the mobile application of mobile computing device 108, if the heat tape and pipe temperatures are below a safety threshold. Similarly, the user can manually deactivate heat tape 112. This manual override capability provides an additional layer of control, empowering the user to act preventively based on their knowledge of local weather conditions. The manual control remains active until the user turns it off, or the heat tape temperature reaches the heat tape temperature safety threshold, eliminating potential damage to the system. This flexible control scheme ensures the user is always in command of their home's water pipe protection.

Settings Modification: The mobile application has two screens for the user to modify system 100 settings to tweak the performance. A system settings screen allows modifying system sample sizes, temperature scale and refresh rates while the dangerous settings screen is intended for advanced users as it modifies thresholds and hysteresis values. If the system is not performing well after modifications, the user can click the “Reset to Factory Settings” button on the dangerous settings screen to return all system settings to the original system factory settings.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a non-transitory machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, such as microcontrollers, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Generally, a computer will also include a communications device. The communication device can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a LED (Light Emitting Diode), OLED (Organic Light Emitting Diode), or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

It should be understood, of course, that the foregoing relates to exemplary embodiments of the invention and that modifications may be made without departing from the spirit and scope of the invention as set forth in the following claims.

What is claimed is:

1. A system for monitoring and controlling a temperature of a pipe, comprising:
a heating apparatus;
at least one processor; and
a memory storing instructions that when executed by the processing cause the processor to perform a method, the method comprising:
receiving, from a sensor, at least one temperature reading of the pipe;
calculating, by the at least one processor, a first temperature condition using the at least one temperature reading;
comparing, by the processor, the first temperature condition to a rapid temperature drop threshold;
in response the first temperature condition being above a threshold, activating, by the processor, the heating apparatus;
in response to the first temperature condition being below the threshold, comparing the at least one temperature reading to a second threshold;
in response to the at least one temperature reading being at or below the second threshold, activating, by the processor, the heating apparatus; and
in response to the at least one temperature reading being above the second threshold, deactivating, by the processor, the heating apparatus.

2. The system of claim 1, wherein calculating the first temperature condition, further comprises:
calculating, using the at least one temperature reading, a difference in temperature over time.

3. A computer implemented method for monitoring and controlling a temperature of a pipe, comprising:
receiving at least one temperature reading of the pipe;
calculating a first temperature condition using the at least one temperature reading;
comparing the first temperature condition to a rapid temperature drop threshold;
in response the first temperature condition being above a threshold, activating the heating apparatus;
in response to the first temperature condition being below the threshold, comparing the at least one temperature reading to a second threshold;
in response to the at least one temperature reading being at or below the second threshold, activating the heating apparatus; and
in response to the at least one temperature reading being above the second threshold, deactivating the heating apparatus.

4. The method of claim 3, wherein calculating the first temperature condition, further comprises:
calculating, using the at least one temperature reading, a difference in temperature over time.

5. A non-transitory computer readable medium storing instructions that when executed cause a processor to:
receive at least one temperature reading of the pipe;
calculate a first temperature condition using the at least one temperature reading;
compare the first temperature condition to a rapid temperature drop threshold;
in response the first temperature condition being above a threshold, activating the heating apparatus;
in response to the first temperature condition being below the threshold, comparing the at least one temperature reading to a second threshold;
in response to the at least one temperature reading being at or below the second threshold, activating the heating apparatus; and
in response to the at least one temperature reading being above the second threshold, deactivating the heating apparatus.

6. The non-transitory computer readable medium of claim 5, wherein calculating the first temperature condition, further comprises:
calculating, using the at least one temperature reading, a difference in temperature over time.
